(19) United States
(12) Patent Application Publication
(10) Pub. No.: US 2018/0275945 A1
(43) Pub. Date: Sep. 27, 2018

(54) INFORMATION PROCESSING APPARATUS, AND NON-TRANSITORY COMPUTER READABLE MEDIUM

(71) Applicant: FUJI XEROX CO.,LTD., Tokyo (JP)

(72) Inventor: Susumu HAMADA, Kanagawa (JP)

(73) Assignee: FUJI XEROX CO.,LTD., Tokyo (JP)

(21) Appl. No.: 15/641,230

(22) Filed: Jul. 4, 2017

(30) Foreign Application Priority Data
Mar. 24, 2017 (JP) 2017-058740

(51) Int. Cl. G06F 3/14; H04N 1/00; H04N 1/44

(52) U.S. Cl. CPC G06F 3/1454; H04N 1/00413; H04N 1/00488; H04N 2201/0075; H04N 1/4413; H04N 2201/0094; H04N 1/00411

(57) ABSTRACT

An information processing apparatus includes a specifying unit that specifies an apparatus suitable for displaying a screen related to a function used by a user to one of the information processing apparatus and an external apparatus, an acquisition unit that acquires information indicating the screen from the external apparatus, in a case where the apparatus specified by the specifying unit is the information processing apparatus, a display unit that displays a screen indicated by the information acquired by the acquisition unit, and an instruction unit that instructs the external apparatus to display the screen, in a case where the apparatus specified by the specifying unit is the external apparatus.

### CROSS-REFERENCE TO RELATED APPLICATIONS

This application is based on and claims priority under 35 USC 119 from Japanese Patent Application No. 2017-058740 filed Mar. 24, 2017.

### BACKGROUND

### Technical Field

The present invention relates to an information processing apparatus, and a non-transitory computer readable medium.

### SUMMARY

In a case where a setting screen of an image forming apparatus is displayed on a portable terminal and setting is performed on the portable terminal, the setting of the image forming apparatus can be performed even in a place away from the image forming apparatus. However, for example, in a case of setting the brightness of a display screen of the image forming apparatus, if the setting screen is displayed on the portable terminal, the setting can be performed on the portable terminal, but the user cannot check the actual brightness of the display screen.

According to an aspect of the invention, there is provided an information processing apparatus including a specifying unit that specifies an apparatus suitable for displaying a screen related to a function used by a user to one of the information processing apparatus and an external apparatus; an acquisition unit that acquires information indicating the screen from the external apparatus, in a case where the apparatus specified by the specifying unit is the information processing apparatus; a display unit that displays a screen indicated by the information acquired by the acquisition unit; and an instruction unit that instructs the external apparatus to display the screen, in a case where the apparatus specified by the specifying unit is the external apparatus.

### BRIEF DESCRIPTION OF THE DRAWINGS

Exemplary embodiment(s) of the present invention will be described in detail based on the following figures, wherein:

FIG. 1 is a diagram showing apparatuses in an information processing system 1 according to an exemplary embodiment of the present invention;

FIG. 2 is a diagram showing an example of a hardware configuration of a terminal apparatus 10;

FIG. 3 is a block diagram showing an example of a configuration of functions realized in the terminal apparatus 10;

FIG. 4 is a diagram showing an example of a hardware configuration of an image forming apparatus 20;

FIG. 5 is a diagram showing an example of a UI table;

FIG. 6 is a block diagram showing an example of a configuration of functions realized in the image forming apparatus 20;

FIG. 7 is a sequence diagram for explaining the operation in the exemplary embodiment;

FIG. 8 is a sequence diagram for explaining the operation in the exemplary embodiment;

FIG. 9 is a diagram showing an example of a screen displayed on the terminal apparatus 10; and

FIG. 10 is a sequence diagram for explaining the operation in the exemplary embodiment.

### DETAILED DESCRIPTION

### Exemplary Embodiment

Overall Configuration

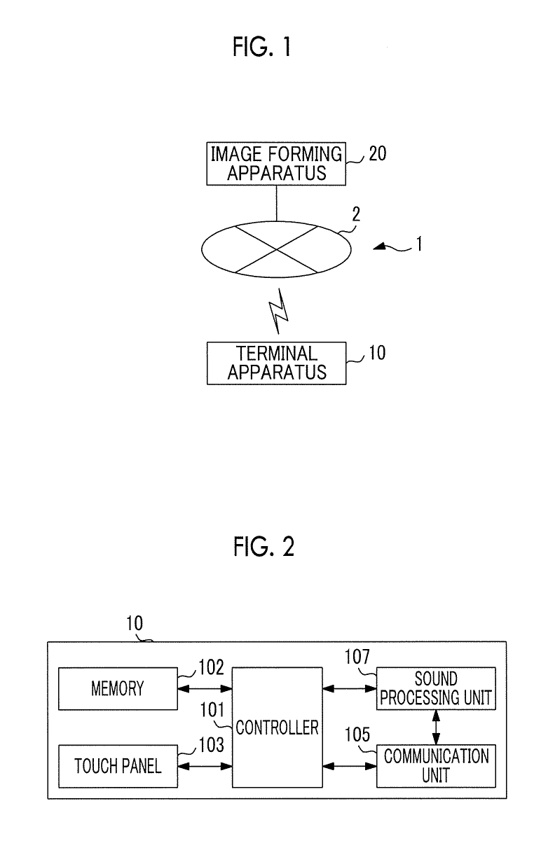

FIG. 1 is a diagram showing apparatuses in an information processing system 1 according to an exemplary embodiment of the present invention. A communication line 2 is a communication line through which data communication is performed, and plural computer devices that perform data communication are connected. The communication line 2 includes wired and wireless communication lines.

The image forming apparatus 20 which is an example of an external apparatus according to an exemplary embodiment of the invention is an apparatus having an image forming function of forming an image on a sheet, a scanning function of reading a document, a copy function, a facsimile function, a photo printing function, and the like. The image forming apparatus 20 is connected to the communication line 2, and is connected to another computer apparatus through the communication line 2 to perform data communication.

The terminal apparatus 10 which is an example of the information processing apparatus according to an exemplary embodiment of the invention is an apparatus that performs data communication, and in this exemplary embodiment, the terminal apparatus 10 is a smartphone. The terminal apparatus 10 accesses the access point of the wireless local area network (LAN) on the communication line 2 so as to be connected to the communication line 2, and performs data communication through the communication line 2. In the present exemplary embodiment, plural terminal apparatuses 10 can be connected to the communication line 2, but in FIG. 1, a single terminal apparatus 10 is shown in order to prevent complication of the drawing. In addition, the terminal apparatus 10 is not limited to a smartphone, but may be, for example, a tablet terminal, a desktop personal computer, or a laptop personal computer.

In an information processing system 1, the terminal apparatus 10 and the image forming apparatus 20 perform communication through the communication line 2, and a screen for performing a remote operation of the image forming apparatus 20, or a screen for setting the image forming apparatus 20 can be displayed on the terminal apparatus 10. By operating the screen displayed on the terminal apparatus 10, it is possible to operate and set the image forming apparatus 20.

Configuration of Terminal Apparatus 10

FIG. 2 is a block diagram illustrating an example of a hardware configuration of the terminal apparatus 10. A touch panel 103 is a combination of a liquid crystal display and a sensor that detects contact of a finger on the display surface of the liquid crystal display. The touch panel 103, which is an example of a display unit according to an exemplary embodiment of the invention, displays characters, graphical user interface (GUI), and the like. Further, in the touch panel 103, the sensor detects the position touched by the user with the finger.

A communication unit 105 functions as a communication interface for performing communication through the communication line 2. Further, the communication unit 105 also functions as a communication interface for performing voice communication and data communication through a mobile communication network.

The sound processing unit 107 includes a microphone and a speaker. In a case where voice communication is performed in the terminal apparatus 10, if a digital signal related to the voice of a communication partner is supplied from the communication unit 105, the sound processing unit 107 converts the supplied digital signal into an analog signal. The analog signal is supplied to the speaker, and the voice of the communication partner is emitted from the speaker. Further, when the microphone picks up the sound, the sound processing unit 107 converts the picked-up sound into a digital signal. In a case where voice communication is performed in the terminal apparatus 10, the sound processing unit 107 supplies the communication unit 105 with the digital signal obtained by converting the voice of the user. The digital signal is transmitted from the communication unit 105 to the mobile communication network, and is transmitted to the terminal apparatus 10 of the communication partner.

The memory 102 includes a memory that permanently stores data. The memory 102 stores a well-known operating system program installed in a smartphone, application programs, and files used in various programs. Further, the memory 102 stores a dedicated application program (hereinafter, referred to as a dedicated application) for operating and setting the image forming apparatus 20, and various types of information used by the dedicated application.

The control unit 101 includes a central processing unit (CPU) and a random access memory (RAM), and executes an operating system program and an application program. The control unit 101 which is executing the program specifies the operation of the user according to the position detected by the touch panel 103 and the screen displayed on the touch panel, and executes control of each unit and various processes according to the specified operation.

Functional Configuration of Terminal Apparatus 10

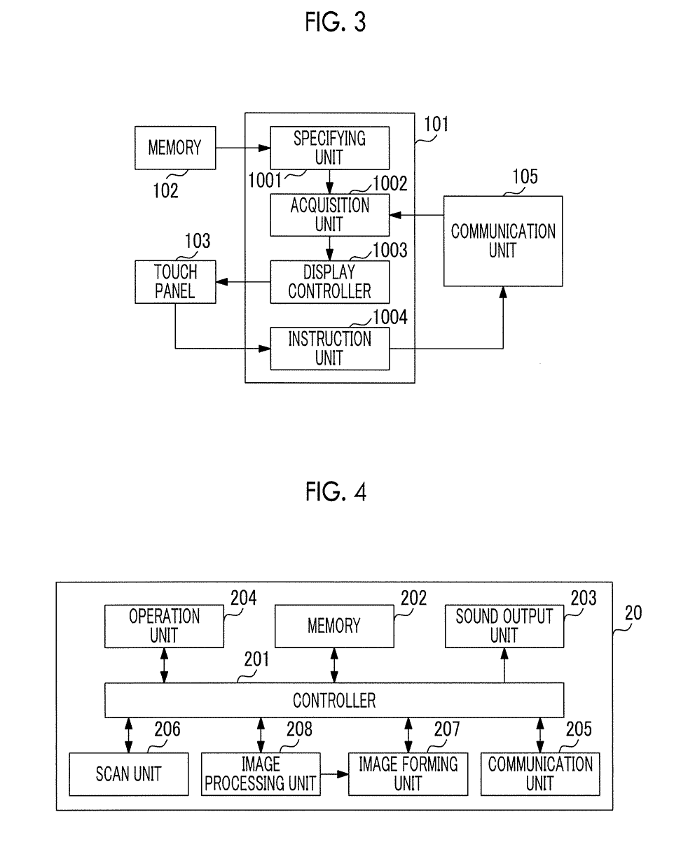

FIG. 3 is a functional block diagram showing an example of a configuration of characteristic functions according to an exemplary embodiment of the invention, among functions realized in the terminal apparatus 10 that has executed the dedicated application. The specifying unit 1001 is an example of specifying unit according to an exemplary embodiment of the invention. The specifying unit 1001 specifies the apparatus suitable for displaying a screen related to a function used by a user in the image forming apparatus 20 to either one of the terminal apparatus 10 and the image forming apparatus 20, with reference to the UI table. The acquisition unit 1002 is an example of acquisition unit according to an exemplary embodiment of the invention. The acquisition unit 1002 acquires from the image forming apparatus 20, information indicating a screen related to a function used by the user in the image forming apparatus 20, in a case where the apparatus specified by the specifying unit 1001 is the terminal apparatus 10. The display control unit 1003 controls the touch panel 103 according to the information acquired by the acquisition unit 1002 such that the screen indicated by the information acquired by the acquisition unit 1002 is displayed. The instruction unit 1004 is an example of the instruction unit according to an exemplary embodiment of the invention. The instruction unit 1004 instructs the image forming apparatus 20 to display a screen related to the function used by the user, in a case where the apparatus specified by the specifying unit 1001 is the image forming apparatus 20.

Configuration of Image Forming Apparatus 20

FIG. 4 is a diagram showing an example of a hardware configuration of the image forming apparatus 20. The operation unit 204 has plural buttons for operating the image forming apparatus 20. Further, the operation unit 204 includes a touch panel which is a combination of a liquid crystal display and a sensor that detects contact of a finger on the display surface of the liquid crystal display. A touch panel which is an example of display unit according to an exemplary embodiment of the invention displays a screen of a GUI for operating the image forming apparatus 20. In the present exemplary embodiment, the image forming apparatus 20 includes a touch panel and can operate the image forming apparatus 20 with the touch panel and buttons, but may be configured to include a liquid crystal display instead of the touch panel, display a GUI screen on the liquid crystal display, and operate the image forming apparatus 20 with buttons.

The communication unit 205 is connected to the communication line 2 in a wired or wireless manner, and performs data communication with other devices connected to the communication line 2. The sound output unit 203 includes a speaker. The sound output unit 203 is controlled by the control unit 201, and outputs sound.

The scan unit 206 includes an image reading device that optically reads a document and generates an image file representing an image of the read document. The image processing unit 208 performs various processes on image data representing an image to be formed on a sheet. The image processing unit 208 performs image processes such as color correction and gradation correction on the image represented by image data supplied from the control unit 201, generates image data of an image of each color of Yellow (Y), Magenta (M), Cyan (C), and Black (K) from the image subjected to the image processes, and outputs the generated image data to the image forming unit 207.

The image forming unit 207 forms a toner image on a sheet by an electrophotographic method. More specifically, the image forming unit 207 includes an image forming unit that forms a toner image of Yellow color, an image forming unit that forms a toner image of a color of Magenta, an image forming unit that forms a toner image of a color of Cyan, and an image forming unit that forms a toner image of a color of Black. Each image forming unit forms an electrostatic latent image on a photosensitive body according to the image data output by the image processing unit 208, attaches the toner to the surface of the photosensitive body to form a toner image of each color of Yellow, Magenta, Cyan, and Black, and transfers the toner image to the paper. Then, heat and pressure are applied to the toner image transferred to the paper to fix the toner image, and then the paper on which the toner image is formed is discharged outside the image forming apparatus 20. The image forming unit 207 forms an image on paper using toner in the present exemplary embodiment, but it may be configured to form an image on paper using an ink as in an ink jet type.

The memory 202 includes a memory device that permanently stores data, and stores document files and image files which are transmitted from another apparatus and received by the communication unit 205, and image files generated by the scan unit 206. Further, the memory 202 stores a UI table that stores information indicating the apparatus suitable for displaying the screen related to the function of the image forming apparatus 20.

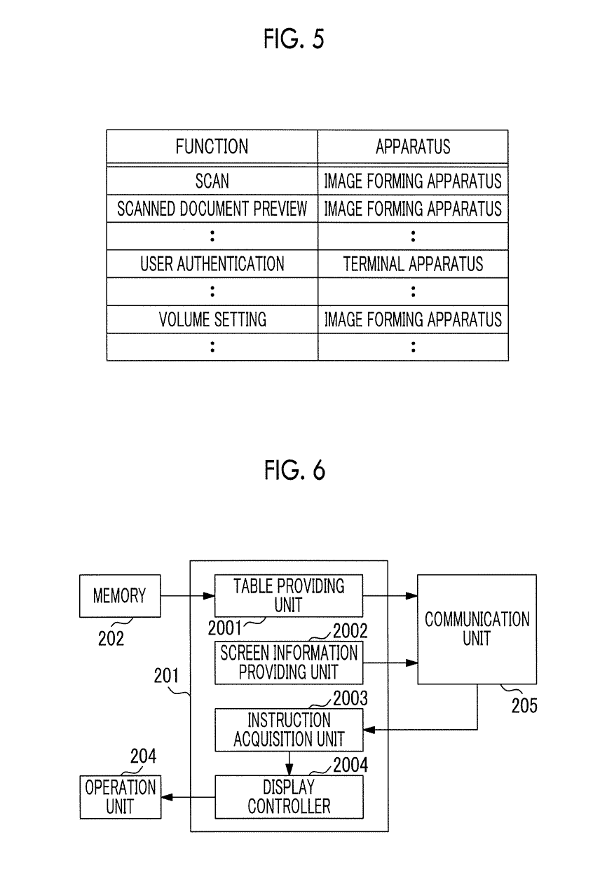

FIG. 5 is a diagram showing an example of the UI table. The UI table has a function field and a device field. In the function field, the function names of the functions of the image forming apparatus 20 are stored. In the device field, information indicating the apparatus suitable for displaying a screen related to the function having the function name stored in the same record is stored.

For example, when an abnormality occurs in the image forming apparatus 20, the image forming apparatus 20 notifies the user of the occurrence of the abnormality by sound. The image forming apparatus 20 has a volume setting function for setting the volume of the sound. In a case where the user is positioned away from the image forming apparatus 20, a GUI screen related to the volume setting function is displayed on the terminal apparatus 10, and the displayed GUI screen is operated, the volume can be set, but the volume cannot be checked by actually listening to the sound. On the other hand, in a case the GUI screen related to the volume setting function is displayed on the operation unit 204, and the displayed GUI screen is operated, a sound corresponding to the volume which is set by the user on the GUI screen is output from the image forming apparatus 20, and the volume can be checked by actually listening to the sound. In this way, since the screen related to the volume setting function may be displayed on the image forming apparatus 20, “Image forming apparatus” is stored in the device field, in the record storing “volume setting” in the function field in the UI table. That is, “Image forming apparatus” is stored in the device field, for the function of the type that may be checked by the image forming apparatus 20.

Further, the image forming apparatus 20 has an authentication function of allowing the user, who has previously been permitted to use by the administrator of the image forming apparatus 20, to use the image forming apparatus 20. Specifically, the image forming apparatus 20 stores the user ID and the password of the user who has previously been permitted to use. The image forming apparatus 20 compares the user ID and the password input by the user with the stored user ID and password, and if the user ID and the password input by the user are stored, the image forming apparatus 20 becomes an available state. When the user inputs a user ID and a password, if an input is made in the operation unit 204 of the image forming apparatus 20, there is a possibility that another user will see the user ID and the password. On the other hand, since the orientation of the terminal apparatus 10 can be easily changed, there is little possibility that other users see the user ID and the password on the terminal apparatus 10. Therefore, in a record in which “user authentication” is stored in the function field of the UI table, “terminal apparatus” is stored in the device field. That is, “terminal apparatus” is stored in the device field, with respect to the function of a confidential type.

The control unit 201 includes a CPU, a RAM, and a memory, and executes programs of the operating system and application programs stored in the memory. The control unit 201 that has executed the application program communicates with the terminal apparatus 10, and realizes the function of executing various processes in response to the instruction from the terminal apparatus 10.

FIG. 6 is a block diagram showing the configuration of the functions according to an exemplary embodiment of the invention, among the functions realized in the image forming apparatus 20. The table providing unit 2001 transmits the UI table to the terminal apparatus 10, in response to the access from the terminal apparatus 10 to the image forming apparatus 20. The screen information providing unit 2002 provides the terminal apparatus 10 with information indicating a screen related to functions provided by the image forming apparatus 20. The instruction acquisition unit 2003 acquires an instruction to display a screen related to functions used by the user, which is an instruction transmitted by the terminal apparatus 10. The display control unit 2004 controls the touch panel in response to the instruction acquired by the instruction acquisition unit 2003, and displays a screen related to the functions used by the user.

### Operation Example of Exemplary Embodiment

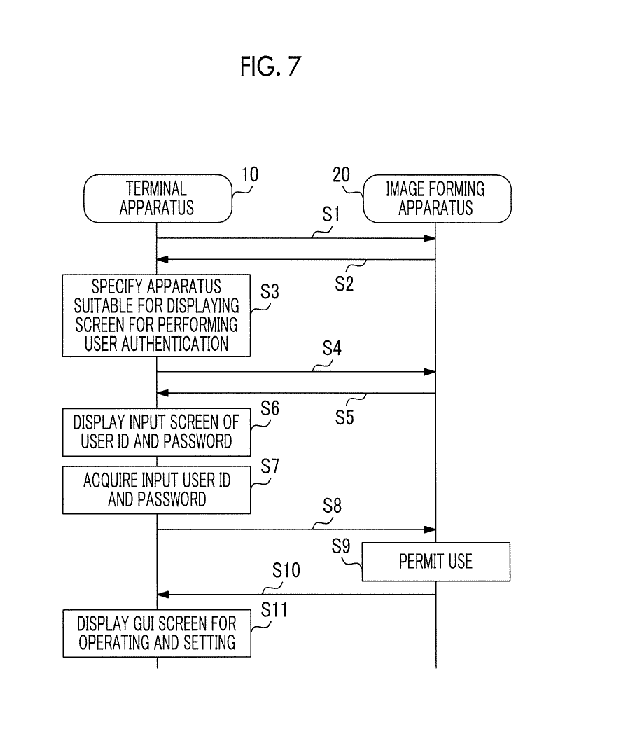

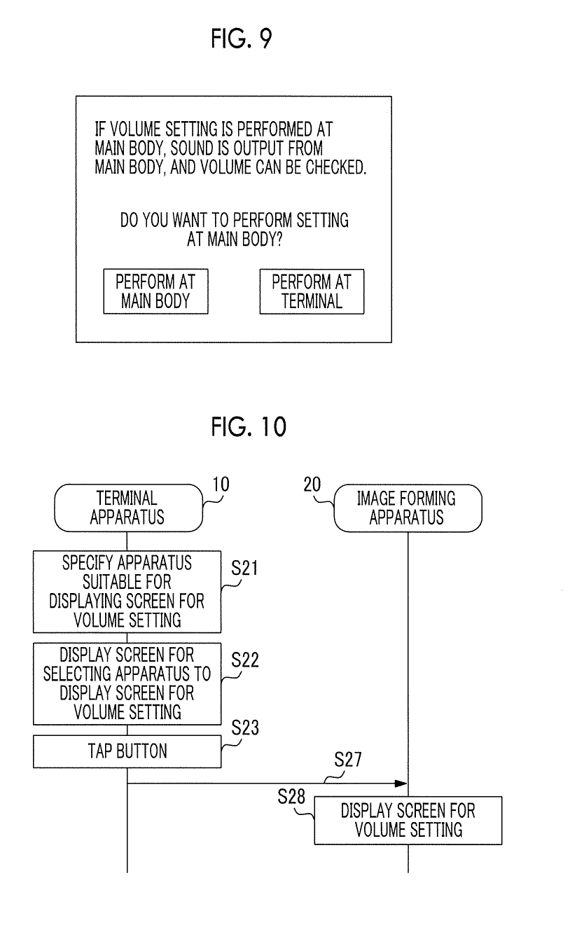

Next, an operation example of the present exemplary embodiment will be described with reference to the screen example of FIG. 9 and the sequence diagrams of FIGS. 7, 8, and 10.

First, the terminal apparatus 10 that has started the dedicated application displays a GUI screen for connection to the image forming apparatus 20. In the terminal apparatus 10 displaying the GUI screen, when the user performs an operation to instruct a connection to the image forming apparatus 20, the terminal apparatus 10 transmits a message requesting the UI table to the image forming apparatus 20 (FIG. 7: step S1).

The image forming apparatus 20 acquires the message transmitted in step S1. The image forming apparatus 20 that has received the message transmitted in step S1 transmits the UI table stored in the memory 202 to the terminal apparatus 10 (step S2). The terminal apparatus 10 acquires the UI table transmitted in step S2, and stores the acquired UI table in the memory 102.

The terminal apparatus 10 that has acquired the UI table specifies the apparatus suitable for displaying a screen for user authentication (step S3). Specifically, the terminal apparatus 10 searches for a record storing “user authentication” in the UI table. When a record storing “user authentication” is hit, the terminal apparatus 10 acquires “terminal apparatus” which is information stored in the device field of the hit record. In a case where the information acquired from the UI table is “terminal apparatus”, the terminal apparatus 10 transmits a message requesting the input screen of the user ID and the password to the image forming apparatus 20 (step S4).

The image forming apparatus 20 acquires the message transmitted in step S4. The image forming apparatus 20 that has acquired the message transmitted in step S4 transmits information indicating the input screen of the user ID and the password to the terminal apparatus 10 (step S5). When the terminal apparatus 10 that has acquired the information transmitted in step S5 controls the touch panel 103 in accordance with the acquired information, the input screen of the user ID and the password is displayed on the touch panel 103 (step S6).

The user operates the touch panel 103 displaying the input screen and inputs the user ID and the password. When the user performs an operation to transmit the user ID and the password which are input next, the terminal apparatus 10 acquires the input user ID and password (step S7), and transmits the acquired user ID and password to the image forming apparatus 20 (step S8).

The image forming apparatus 20 acquires the user ID and the password transmitted in step S6. When the same set as the set of the user ID and the password which are acquired is stored in the memory 202, the image forming apparatus 20 permits the user to use the image forming apparatus 20 (step S9). Upon permitting the user to use the image forming apparatus 20, the image forming apparatus 20 transmits information on the GUI screen for operating and setting the image forming apparatus 20 to the terminal apparatus 10 (step S10).

The terminal apparatus 10 acquires the information transmitted in step S10. When the terminal apparatus 10 that has acquired the information transmitted in step S10 controls the touch panel 103 according to the acquired information, the GUI screen for operating and setting the image forming apparatus 20 is displayed on the touch panel 103 (step S11).

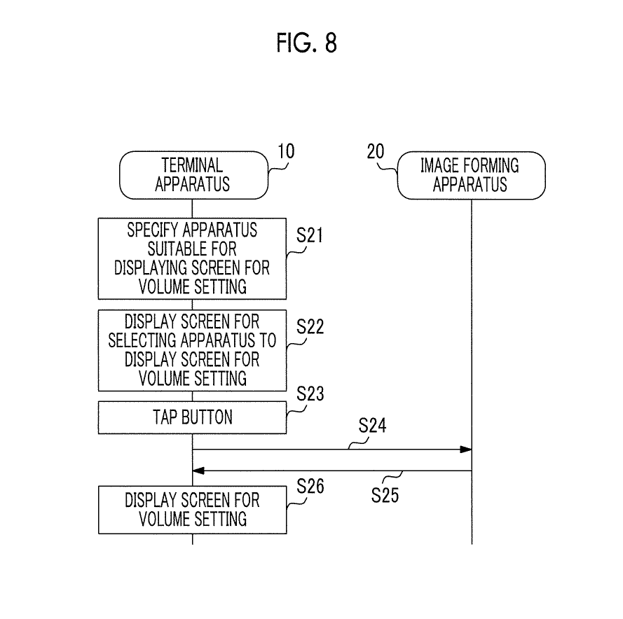

When the user performs an operation to instruct display of a volume setting screen on the GUI screen displayed on the touch panel 103 by the above-described operation, the terminal apparatus 10 specifies the apparatus suitable for displaying a screen for volume setting (FIG. 8: step S21). Specifically, the terminal apparatus 10 searches for a record storing “volume setting”, in the UI table in the memory 102. When the record storing “volume setting” is hit, the terminal apparatus 10 acquires “image forming apparatus” which is information stored in the device field of the hit record.

In a case where the information acquired from the UI table is the “image forming apparatus”, the terminal apparatus 10 displays a screen asking the user which one of the terminal apparatus 10 and the image forming apparatus 20 is to display the GUI screen for volume setting (step S22).

FIG. 9 is a diagram showing an example of the screen displayed on the touch panel 103 in step S22. Since the volume of the sound emitted from the image forming apparatus 20 may be actually listened in order to determine the volume of the sound output from the image forming apparatus 20, the screen displayed in step S22 contains a sentence explaining that the volume may be set in the main body (the image forming apparatus 20). When the user performs an operation of tapping the “perform at a terminal” button on the screen shown in FIG. 9 (step S23), the terminal apparatus 10 transmits a message indicating that the volume setting is to be performed in the terminal apparatus 10, to the image forming apparatus 20 (step S24).

The image forming apparatus 20 acquires the message transmitted in step S24. Since the content of the acquired message indicates that the volume setting is to performed at the terminal apparatus 10, the image forming apparatus 20 that has acquired the message transmitted in step S24 transmits information indicating a screen for setting the volume to the terminal apparatus 10 (step S25). The terminal apparatus 10 acquires the information transmitted in step S25. When the terminal apparatus 10 that has acquired the information transmitted in step S25 controls the touch panel 103 according to the acquired information, a screen for setting the volume is displayed on the touch panel 103 (step S26).

On the other hand, in a case where the user performs an operation of tapping the “perform at a main body” button on the screen shown in FIG. 9, the terminal apparatus 10 transmits a message indicating that the volume setting is to be performed at the image forming apparatus, to the image forming apparatus 20 (FIG. 10: step S27).

The image forming apparatus 20 acquires the message transmitted in step S27. When the content of the acquired message indicates that the volume setting is performed by the image forming apparatus, the image forming apparatus 20 that has acquired the message transmitted in step S24 displays a screen for setting the volume on the touch panel of the operation unit 204 (step S28). When the user operates the screen displayed on the touch panel of the operation unit 204 and sets the volume, the image forming apparatus 20 outputs the sound corresponding to the set volume from the sound output unit 203. Here, the user can set the volume while listening to the sound output according to the operation.

### Modification Examples

Although the exemplary embodiment of the present invention has been described above, the present invention is not limited to the above-described exemplary embodiment, and can be implemented in various other modes. For example, the present invention may be implemented by modifying the above-described exemplary embodiment as follows. Note that the above-described exemplary embodiment and the following modification examples may be combined.

### Modification Example 1

The UI table is transmitted from the image forming apparatus 20 to the terminal apparatus 10, and the terminal apparatus 10 specifies an apparatus suitable for displaying the screen in the above-described exemplary embodiment, but the image forming apparatus 20 may be configured to specify the apparatus suitable for displaying the screen. In the case of this configuration, the image forming apparatus 20 is an example of the information processing apparatus according to an exemplary embodiment of the invention. In the present modification example, for example, when the user performs an operation to instruct display of the volume setting screen, the terminal apparatus 10 transmits a message requesting the volume setting screen, to the image forming apparatus 20. The image forming apparatus 20 that has acquired this message searches for a record storing “volume setting”, in the UI table in the memory 202. When the record storing “volume setting” is hit, the image forming apparatus 20 acquires “image forming apparatus” which is information stored in the device field of the hit record. In a case where the information acquired from the UI table is the “image forming apparatus”, the image forming apparatus 20 transmits information on a screen asking the user which one of the terminal apparatus 10 and the image forming apparatus 20 is to display the GUI screen for volume setting, to the terminal apparatus 10. The terminal apparatus 10 displays a screen (FIG. 9) asking the user which one of the terminal apparatus 10 and the image forming apparatus 20 is to display the GUI screen for volume setting, based on the information transmitted from the image forming apparatus 20.

When the user performs an operation of tapping the “perform at a terminal” button, the terminal apparatus 10 transmits a message indicating that the volume setting is to be performed in the terminal apparatus 10, to the image forming apparatus 20. The image forming apparatus 20 acquires the message transmitted by the terminal apparatus 10. Since the content of the acquired message indicates that the volume setting is to be performed in the terminal apparatus 10, the image forming apparatus 20 transmits information indicating a screen for volume setting to the terminal apparatus 10. The terminal apparatus 10 acquires the information transmitted from the image forming apparatus 20. When the touch panel 103 is controlled according to the information acquired by the terminal apparatus 10, a screen for volume setting is displayed on the touch panel 103. In a case where the user performs the operation of tapping the “perform at a main body” button on the screen shown in FIG. 9, the operation is the same as that in the above-described exemplary embodiment, so the explanation thereof will be omitted.

Further, when an operation of instructing display of a screen for user authentication is performed, the terminal apparatus 10 transmits a message requesting a screen for user authentication, to the image forming apparatus 20. The image forming apparatus 20 that has acquired this message searches for a record storing “user authentication”, in the UI table in the memory 202. When a record storing “user authentication” is hit, the image forming apparatus 20 acquires “terminal apparatus” which is information stored in the device field of the hit record. In a case where the information acquired from the UI table is “terminal apparatus”, the image forming apparatus 20 transmits information indicating the input screen of the user ID and the password, to the terminal apparatus 10. The terminal apparatus 10 acquires the information transmitted from the image forming apparatus 20. When the touch panel 103 is controlled according to the information acquired by the terminal apparatus 10, a screen for inputting a user ID and a password is displayed on the touch panel 103.

### Modification Example 2

According to an exemplary embodiment of the invention, in the UI table, a screen size field may be provided instead of the device field, and the screen size may be stored in the screen size field. In the case of a configuration in which the screen size field is provided in the UI table, the corresponding screen size may be stored for each function name in the screen size field, and some functions may have different stored screen sizes from the screen sizes of other functions.

For example, in a record in which “scanned document preview” is stored in the function field, a UI table is provided in which “10 inches” is stored in the screen size field. In a case where an operation of using the preview function of the scanned document is performed, the terminal apparatus 10 that has acquired the UI table acquires the screen size of the touch panel 103, and acquires the screen size from the record storing the “scanned document preview” in the UI table.

In a case where the acquired screen size of the touch panel 103 is equal to or larger than the screen size acquired from the UI table, the terminal apparatus 10 transmits a message requesting the preview screen of the scanned document, to the image forming apparatus 20. Upon acquiring the message, the image forming apparatus 20 transmits information indicating the preview screen, to the terminal apparatus 10. The terminal apparatus 10 that has acquired the information displays the preview screen of the scanned document according to the information transmitted from the image forming apparatus 20.

On the other hand, in a case where the acquired screen size of the touch panel 103 is smaller than the screen size acquired from the UI table, the terminal apparatus 10 transmits a message requesting a screen asking the user which one of the terminal apparatus 10 and the image forming apparatus 20 is to display the preview screen of the scanned document, to the image forming apparatus 20. Upon acquiring the message, the image forming apparatus 20 transmits information on a screen asking the user which one of the terminal apparatus 10 and the image forming apparatus 20 is to display the preview screen, to the terminal apparatus 10. The terminal apparatus 10 displays a screen for selecting one of the terminal apparatus 10 and the image forming apparatus 20 which is to display the preview screen, based on the information transmitted from the image forming apparatus 20 on the touch panel 103. In this screen, since the screen size of the terminal apparatus 10 is small, a sentence explaining that the preview screen may not be displayed on the terminal apparatus 10 is included.

The screen to be displayed has buttons “perform at a terminal” and “performs at a main body”. When the user performs an operation of tapping the “perform at a main body” button on the displayed screen, the terminal apparatus 10 transmits a message indicating that the preview screen of the scanned document is to be displayed on the image forming apparatus 20, to the image forming apparatus 20. The image forming apparatus 20 acquires a message transmitted from the terminal apparatus 10. When the contents of the acquired message are contents indicating that the image forming apparatus 20 displays the preview screen of the scanned document, the image forming apparatus 20 displays the preview screen of the scanned document.

On the other hand, when the user performs an operation of tapping the “perform at a terminal” button on the displayed screen, the terminal apparatus 10 transmits a message indicating that the preview screen of the scanned document is to be displayed on the terminal apparatus 10, to the image forming apparatus 20. The image forming apparatus 20 acquires a message transmitted from the terminal apparatus 10. When the contents of the acquired message are contents indicating that the terminal apparatus 10 displays the preview screen of the scanned document, the image forming apparatus 20 transmits information indicating the preview screen of the scanned document to the terminal apparatus 10. The terminal apparatus 10 displays the preview screen of the scanned document on the touch panel 103, based on the information transmitted from the image forming apparatus 20.

### Modification Example 3

In the above-described exemplary embodiment, the apparatus that is remotely operated and set by the terminal apparatus 10 is the image forming apparatus 20, but the apparatus that is remotely operated and set by the terminal apparatus 10 is not limited to the image forming apparatus 20. For example, the apparatus that is remotely operated and set by the terminal apparatus 10 may be home appliances such as video equipment, audio equipment, white home appliances, and information home appliances. In a case where the apparatus that is remotely operated and set by the terminal apparatus 10 is a home appliance, the home appliance is an example of the information processing apparatus according to an exemplary embodiment of the invention.

### Modification Example 4

According to an exemplary embodiment of the invention, when the function of the function name stored in the record storing “image forming apparatus” in the device field of the UI table is used, the history of the apparatus displaying the screen related to the used function may be stored in the memory 202. In addition, in the configuration in which the history of the apparatus displaying the screen related to the used function is stored in the memory 202, the stored history may be viewed by the administrator of the image forming apparatus 20.

Further, for example, with respect to the function of the function name stored in the record storing “image forming apparatus” in the device field of the UI table, the image forming apparatus 20 may determine whether or not the number of times that terminal apparatus 10 displays the screen related to the used function is equal to or more than a predetermined threshold, and in a case where the number of times that terminal apparatus 10 displays the screen related to the used function is equal to or more than the predetermined threshold, the image forming apparatus 20 may propose to the administrator of the image forming apparatus 20 to rewrite the UI table.

### Modification Example 5

In the exemplary embodiment described above, the terminal apparatus 10 communicates with the image forming apparatus 20 by executing a dedicated application, and displays a screen for operating and setting the image forming apparatus 20, but the configuration of displaying the screen for operating and setting the image forming apparatus 20 is not limited to the configuration of the exemplary embodiment. For example, in a case where the terminal apparatus 10 operates or sets the image forming apparatus 20, the image forming apparatus 20 may be operated and set in the Web application operating on the Web browser.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a specifying unit that specifies an apparatus suitable for displaying a screen related to a function used by a user to one of the information processing apparatus and an external apparatus;
an acquisition unit that acquires information indicating the screen from the external apparatus, in a case where the apparatus specified by the specifying unit is the information processing apparatus;
a display unit that displays a screen indicated by the information acquired by the acquisition unit; and
an instruction unit that instructs the external apparatus to display the screen, in a case where the apparatus specified by the specifying unit is the external apparatus.

2. The information processing apparatus according to claim 1,
wherein the specifying unit specifies the apparatus suitable for displaying the screen related to the function used by the user, depending on a type of the function.

3. The information processing apparatus according to claim 2,
wherein the specifying unit specifies the information processing apparatus, in a case where the function used by the user is a confidential function.

4. The information processing apparatus according to claim 1,
wherein the specifying unit specifies the apparatus suitable for displaying the screen related to the function used by the user, depending on a screen size of the information processing apparatus.

5. The information processing apparatus according to claim 4,
wherein the screen size suitable for displaying the screen related to the function is determined for each of plurality of functions, and
wherein the specifying unit specifies the apparatus suitable for displaying the screen related to the function used by the user, depending on a relationship between the screen size suitable for displaying the screen related to the function and the screen size of the information processing apparatus.

6. An information processing apparatus comprising:
a specifying unit that specifies an apparatus suitable for displaying a screen related to a function used by a user to one of the information processing apparatus and a terminal apparatus;
a providing unit that provides information indicating the screen to the terminal apparatus, in a case where the apparatus specified by the specifying unit is the terminal apparatus; and
a display unit that displays the screen, in a case where the apparatus specified by the specifying unit is the information processing apparatus.

7. A non-transitory computer readable medium storing a program causing a computer to function as:
a specifying unit that specifies an apparatus suitable for displaying a screen related to a function used by a user to one of the computer and a terminal apparatus;
a providing unit that provides information indicating the screen to the terminal apparatus, in a case where the apparatus specified by the specifying unit is the terminal apparatus; and
a display unit that displays the screen, in a case where the apparatus specified by the specifying unit is the computer.
